(19) United States
(12) Patent Application Publication
(10) Pub. No.: US 2025/0264383 A1
(43) Pub. Date: Aug. 21, 2025

(54) MICROTOME WITH AUTOMATED ADJUSTMENT AND METHOD THEREFOR

(71) Applicant: Leica Mikrosysteme GmbH, Vienna (AT)

(72) Inventors: Florian EDTHOFER, Vienna (AT); Matthias KATZENGRUBER, Vienna (AT); Siegfried TANKI, Vienna (AT); Paul WURZINGER, Vienna (AT)

(21) Appl. No.: 19/053,443

(22) Filed: Feb. 14, 2025

(30) Foreign Application Priority Data
Feb. 19, 2024 (DE) 102024104594

(51) Int. Cl. G01N 1/28; G01N 35/00

(52) U.S. Cl. CPC G01N 1/286; G01N 35/00584; G01N 2001/2873

(57) ABSTRACT

A microtome includes one or more motor drives for moving a sample and for moving a knife, and a user interface. The microtome is configured to detect a position of the sample, detect a position of the knife, obtain adjustment information about the sample, obtain adjustment information about the knife, and adjust the microtome based on the position of the sample, the position of the knife, the adjustment information about the sample, the adjustment information about the knife, and a command from the user interface.

### CROSS REFERENCE TO RELATED APPLICATIONS

This application claims benefit to German Patent Application No. DE 102024104594.9, filed on Feb. 19, 2024, which is hereby incorporated by reference herein.

### FIELD

Embodiments of the present invention relate to microtomes with at least partially automated adjustment and methods for automated adjustment.

### BACKGROUND

A microtome is used to create very thin sections of samples for microscopic examinations. For this purpose, a sample may be prepared using an embedding medium, frequently paraffin or resin, and clamped in a sample holder. The section thickness can be selected by a user on the microtome, usually within a range of a few micrometers. The sample is then moved by the user against a sharp knife (or vice versa) that creates thin sections. It is important to hold the sample stable during cutting and to adapt the cutting speed to the sample properties. A microtome is usually calibrated or adjusted prior to use. In this process, the knife is aligned relative to the sample or to the sample holder. Mechanical disturbances, caused in particular by inexperienced or inattentive users, can adversely affect the adjustment or a later cutting result. Improvements in this area are desirable.

### SUMMARY

Embodiments of the present invention provide a microtome. The microtome includes one or more motor drives for moving a sample and for moving a knife, and a user interface. The microtome is configured to detect a position of the sample, detect a position of the knife, obtain adjustment information about the sample, obtain adjustment information about the knife, and adjust the microtome based on the position of the sample, the position of the knife, the adjustment information about the sample, the adjustment information about the knife, and a command from the user interface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a microtome according to some embodiments;

FIG. 2 illustrates a method for adjusting a microtome according to some embodiments;

FIG. 3 illustrates a method for adjusting a microtome according to some embodiments;

FIG. 4 illustrates a method for adjusting a microtome according to some embodiments; and

FIG. 5 shows microscope systems according to some embodiments.

### DETAILED DESCRIPTION

Embodiments of this disclosure provide to improve working with a microtome.

A first aspect of the present disclosure relates to a microtome, including one or more motor drives for moving a sample and for moving a knife, and a user interface;

configured to:
detect a position of the sample;
detect a position of the knife;
obtain adjustment information about the sample;
obtain adjustment information about the knife;
adjust the microtome based on the detected positions, the adjustment information, and a command from the user interface.

A microtome is a device for sectioning samples and can be used for examining microscopic structures of tissues, such as biological tissues, and/or other material. A microtome can be used to cut one or more slices from a sample that are thin enough (e.g., transparent) to be examined in detail under a microscope. For alignment and cutting purposes, a microtome may include a microscope and/or a camera capable of capturing a cutting area/sample area of a microtome, so that this area can be imaged. A knife of a microtome may be made of diamond or glass.

A microtome may be operated at room temperature or, as a cryomicrotome, for examining frozen samples. A microtome may be a rotary microtome suitable for cutting thin sections of tissue. A microtome may also be an ultramicrotome suitable for cutting ultrathin sections for electron microscopy. A microtome may be a laser microtome capable of non-contact cutting of samples.

A microtome may be configured such that a sample holder and a blade holder can be moved relative to each other. This may be accomplished by moving only the sample holder, by moving only the blade holder (i.e., the sample holder is fixed), and/or by moving the sample holder and the blade holder. A sample holder, also referred to as chuck, may be used to securely position the sample to be sectioned. A sample holder may be configured to hold the sample firmly and in correct alignment, so that precise and uniform cuts can be achieved. A sample holder may be adjustable, so that the sample can be aligned relative to the cutting blade so as to obtain a desired cutting angle and a desired thickness.

A sample may be an arbitrary piece of material or different materials that can be cut into slices. A sample may include, for example, biological tissue from different organs which is suitable for diagnosis of diseases and for research, or plant material. Moreover, cultivated cells and hard tissue, such as bones, can also be cut into slices. The desired thickness of a section may range from millimeters to a few micrometers or even nanometers. In order to achieve these layer thicknesses.

In the context of this disclosure, obtaining information (e.g., adjustment information) may include receiving and/or retrieving this information. In addition or alternatively, obtaining may include determining an item of information based on other received/retrieved information.

Adjustment information may be obtained, for example, from a user interface. In addition or alternatively, adjustment information may be obtained from a manufacturer of a microtome and/or of a knife for a microtome. Adjustment information may itself on data and/or instructions that are used for adjustment (i.e., the fine adjustment or calibration) of a microtome. An adjustment may serve to improve an accuracy, a performance and/or a reliability of a microtome, in particular by correcting deviations from the desired values. Adjustment information may include different types of information: reference values, target information, in particular target positions and/or target distances to be reached, instructions for performing the adjustment, including tools and methods to be used, information on tolerance ranges within which the microtome functions correctly. Detecting the positions of the sample and the knife serves to control an adjustment operation, i.e., for adjustment purposes.

A microtome according to the first aspect of the present disclosure allows adjustment to be performed in a partially or fully automated manner, so that external disturbances, for example, mechanical vibrations caused by an operator, can be avoided or reduced. Accordingly, an adjustment may be initiated by a command via a user interface, and may then take place substantially automatically. In addition or alternatively, an adjustment may be partially controlled by a user at the user interface. The thinner the desired sections, the more important it is to avoid disturbances. For example, a microtome operator may activate an adjustment and then leave the room in which the microtome is located. After that, the adjustment may be performed automatically.

An embodiment of a first aspect of the present disclosure relates to a microtome, where the user interface includes a remote user interface and the adjustment is controlled via the remote user interface.

A control operation may include activating and/or initiating an adjustment. Thus, an adjustment may be performed without a user being present in the room. This makes it possible to avoid mechanical disturbances caused by the user (for example, by stepping or by touching the microtome).

Activation information, and also information for alignment of a knife, a sample holder, and/or of a sample, may be received via a remote user interface. For example, an adjustment may be specified such that a cut can be made parallel or obliquely to a block face (part of a sample to be sectioned).

A remote user interface may in particular be configured to communicate with a plurality of microtomes. This allows adjustment to be performed for the plurality of microtomes connected to the user interface.

An embodiment of a first aspect of the present disclosure relates to a microtome, configured to:
obtain a command for positioning the sample and/or the knife during the adjustment from the user interface, in particular via a remote user interface.

This allows an operator to select how an adjustment is to be performed. Such a selection may be a starting position. An operator may in particular move a sample and/or a knife to a certain position from where an automatic adjustment can or is to start. Such a selection can in particular save time, for example because it reduces the distance to be traveled during automatic adjustment. When such a selection comes from a remote user interface, i.e., a user interface which, in particular, is not located in the same room as the microtome, the selection can be made without direct contact with the microtome. This reduces mechanical disturbances on the microtome and on the adjustment to be performed.

An embodiment of a first aspect of the present disclosure relates to a microtome, where the positioning command includes one or more of the following information items:
position-based information;
shape-based information.

Position-based information may be a position, a speed, an acceleration, etc. Position-based information may be based on predefined markings or on a shape of the sample or of the knife.

For example, an adjustment may be made such that a distance between the knife and the sample must be maintained as the knife moves relative the sample in the cutting direction. Such adjustment may ensure that a cut is made along a straight line and not along a curved line. A distance between the knife and the sample may be monitored by a camera, and the knife or the sample may be adjusted by tilting such that, during linear movement, a predetermined distance does not change or changes within predetermined limits.

In addition or alternatively, an adjustment may be performed such that a knife and a surface of the sample (of the block face) must be parallel to each other. For this purpose, in particular, a shape of a light gap between the knife and the sample may be detected and analyzed. For example, a top edge of a sample surface (i.e., of the block face) may be disposed parallel to the cutting edge of a knife. A sample may have a plurality of surfaces, a surface constituting a sample surface. Consequently, the cutting edge may be parallel to a defined surface of the sample. This surface may be specified by a user. A side may also be defined by a mirror image or a reflection of a cutting edge in a sample surface of the sample. A reflection of another structure, for example, a marking in the cutting knife or in the knife holder, may also be used for alignment.

In addition or alternatively, a user may select a specific adjustment method by providing specific information. For example, a distance-based adjustment may be performed by specifying a distance to be maintained. A shape-based adjustment may be defined by maintaining a predetermined shape of the light gap.

An embodiment of a first aspect of the present disclosure relates to a microtome, where one or more of the following commands are captured by the user interface, in particular by a remote user interface:
a command to start the adjustment;
a command to terminate the adjustment;
a command to interrupt the adjustment;
a command to perform a manual adjustment.

A command to start the adjustment may in particular include a timer. Thus, a user may start an adjustment and may then walk away from the microtome or leave the room. Then, the adjustment can be performed without disturbance. The timer may, for example, be set such that the adjustment starts 30s after activation by a user. In addition or alternatively, the start of an adjustment may be linked to one or more conditions. For instance, a start may be commanded, but may not occur operationally until a sensor or other means indicates that the user has left the room in which the microtome is located. This too can ensure that an adjustment can be performed without disturbance.

An adjustment may be interrupted or terminated, in particular when disturbances, in particular mechanical disturbance, are detected. For example, an adjustment may be interrupted when a sensor detects vibrations. In addition or alternatively, an adjustment may be interrupted when a user is detected at the microtome or in the room.

A manual adjustment may be performed in particular after an automated adjustment that has not yet been completed, and thus in cases where manual adjustment by the user is more accurate than automated adjustment.

An embodiment of a first aspect of the present disclosure relates to a microtome, including one or more position sensors for detecting the position of the sample and/or the position of the sample holder.

In addition to a camera, other position sensors that can be used to measure positions for an adjustment include position sensors disposed directly on the motors and/or on the joints of the sample holder and of the knife. Moreover, redundant acquisition of specific position information is also possible, such as measurement of the position of a sample holder by a sensor on the sample holder and by a camera. The two items of position information may then be integrated using the maximum likelihood method to minimize a measurement error caused, for example, by mechanical disturbances (e.g., human steps near the microtome).

An embodiment of a first aspect of the present disclosure relates to a microtome, including a camera for simultaneously detecting the position of the sample and/or the position of the sample holder and the position of the knife.

A camera can detect various positions simultaneously. The parts to be detected and tracked (sample holder, sample, knife, knife holder) may have markings that can be easily identified by visual image processing, so that a position of the respective part can be determined on this basis.

An embodiment of a first aspect of the present disclosure relates to a microtome, where adjustment information of the sample may include the following information:
a position on the sample holder;
a position on a block face of the sample;
a distance from the sample or from the sample holder;
a marking on the sample or on the sample holder;
a geometric property of the sample or of the sample holder.

A position on the sample holder, on the block face may be predetermined points, for example, on a corner, along an edge, or on a surface.

A position may in particular be marked, for example, by a visually and/or electromagnetically detectable marking. In addition or alternatively, a position may be determined by a special sensor system configured to measure this position alone, for example, a laser position sensor and/or a joint sensor. For purposes of adjustment, for example, one or more markings on the sample and/or on the sample holder may be synchronized with one or more markings on the knife and/or on the knife holder such that, for example, the points on the sample and/or on the sample holder assume positions spaced a minimum distance or a predetermined distance from the points on the knife and/or on the knife holder.

An adjustment may also be performed based on certain geometric features, such as a corner, an edge, and/or a surface of a sample or of a block face.

An embodiment of a first aspect of the present disclosure relates to a microtome, where adjustment information of the knife may include any of the following information:
a position on a knife holder;
a position on the knife, in particular a position of a segment of the knife;
a distance from the knife and/or from the knife holder;
a marking on the knife or on the knife holder;
a geometric property of the knife or of the knife holder.

A position on the knife and/or on the knife holder can be detected by the same or similar means as a position on a sample or on a sample holder. This also applies to distance determination. An adjustment may also be performed based on markings and/or certain geometric features, such as a corner, an edge, a segment, and/or a surface of a knife.

An embodiment of a first aspect of the present disclosure relates to a microtome, where the sample and/or the knife include(s) one or more position markings.

In particular, a plurality of position markings may be arranged at a predetermined spacing, thus forming a scale. Based on the predetermined spacing, the amount by which the sample and the knife are shifted relative to each other can be determined, for example, by a camera-based visual analysis.

An embodiment of a first aspect of the present disclosure relates to a microtome, where both the sample and the knife have position markings forming a vernier.

A vernier includes a movable scale. This movable scale is calibrated such that its markings have a slightly different pitch than those of a main scale over certain length. The main scale may be either the scale on a sample or the scale on a knife. A vernier scale may, for example, be adjusted such that ten vernier graduation lines on a knife are above nine graduation lines on a sample. The difference between the graduations enables an automatic image processing system (or an operator) to determine the value between the main scale graduations more accurately by comparing the alignment of the markings on the two scales, and thus, to identify an offset between the sample and knife with high accuracy or to reduce this offset by making an appropriate adjustment.

An embodiment of a first aspect of the present disclosure relates to a microtome, configured to:
check whether there are sources of mechanical disturbances near the microtome.

Such checking may be performed via suitable sensors on the microtome or in the vicinity of the microtome. Disturbances may originate in particular from external influences. Disturbances may be, for example, external vibrations caused by machines, humans, or even building movements. Disturbances may also be due to temperature variations. Although not directly a source of mechanical disturbances, temperature variations can lead to mechanical expansions or contractions of the components of the microtome (sample, sample holder, knife, etc.), which in turn may affect the accuracy of an adjustment. In addition, disturbances may be based on air currents. Disturbances may also originate from dirt and foreign matter. Dust, dirt, and other foreign matter entering a mechanism of the microtome can restrict the freedom of movement of the moving parts or lead to inconsistent sections or inaccurate adjustment. Accordingly, a sensor system may be provided for one or more of these types of disturbance so as to allow an adjustment to be performed, in particular to be started, interrupted, or terminated, based on predetermined thresholds.

An embodiment of a first aspect of the present disclosure relates to a microtome, including a pump for emptying and filling a water tank disposed on the knife.

Water in the water tank can lead to contamination of a sample or of a knife during adjustment, for example, because of electrostatic effects. Accordingly, water contained in the water tank may be removed or its quantity reduced by a pump prior to an adjustment. After that, an adjustment can be made. Upon completion of the adjustment, a pump may refill a water tank with a sufficient quantity of water, in particular prior to a cutting operation.

In another embodiment, which may be implemented with or without a pump, a water tank may already be filled prior to an adjustment, so that a cutting operation of the microtome can be started immediately after the adjustment, without a user having to return to the microtome to fill water (in cases where there is no controllable pump).

An embodiment of a first aspect of the present disclosure relates to a microtome, where one or more of the following commands are captured by the user interface, in particular by a remote user interface:
a command to empty a water tank of the knife;
a command to fill a water tank of the knife.

A command to empty a water tank may be issued in particular prior to an adjustment, but in other cases also after an adjustment. The latter is possible in particular when the adjustment can be performed so smoothly that water movements are not harmful to the sample.

In particular, electrostatic perturbations can also be mitigated by ensuring that the knife/knife holder (which includes a water tank) and the sample/sample holder are at the same electrical potential, in particular ground potential. This can be achieved, for example, by galvanic coupling (e.g., via a wired connection) of the respective microtome components.

A command to fill a water tank may be issued in particular after completion of an adjustment. Alternatively, a command to fill a water tank with water may also be issued prior to an adjustment, especially in the scenario described in the preceding paragraph.

A second aspect of the present disclosure relates to a computer-implemented method for adjusting a microtome,

including the steps of:
detecting a position of a sample;
detecting a position of a knife;
obtaining adjustment information about the sample;
obtaining adjustment information about the knife;
obtaining an adjustment command via a user interface, in particular a remote user interface;
adjusting the sample relative to the knife based on the detected positions, the adjustment positions, and the adjustment command.

The method may in particular be adapted for adjusting a microtome according to the first aspect. For this purpose, the method may include steps and/or functions as described in connection with the first aspect of the present disclosure or for operating microscope components as described in connection with the first aspect of the present disclosure.

The method may be carried out on a microtome according to the first aspect of the present disclosure or on a computer that is independent of a microtome and connected to a microtome and a user interface only via a communication infrastructure, for example, a network. Information from external sensors, for example, a room sensor for monitoring a human-free room, may also be connected via this communication infrastructure.

Further advantages and features will be apparent from the following embodiments, which partly refer to the figures. In the figures, the embodiments are not always shown to scale. For purposes of clarity of the description, the dimensions of the various features may be enlarged or reduced. For this purpose, the figures are at least partly schematic.

In the following description, reference is made to the accompanying figures which form part of the disclosure, and which illustrate specific aspects and embodiments to provide an understanding of the present disclosure. Like reference characters refer to the same or at least functionally or structurally similar features.

In general, a disclosure of a described method also applies to a corresponding device for carrying out the method or a corresponding system including one or more devices, and vice versa. For example, if a specific method step is described, a corresponding device may include a feature to perform the described method step, even if this feature is not explicitly described or illustrated in the figure. On the other hand, if, for example, a specific device is described based on functional units, a corresponding method may include one or more steps for performing the described functionality, even if such steps are not explicitly described or illustrated in the figures. Similarly, a system may include corresponding device features or features for performing a particular method step. The features of the various exemplary aspects and embodiments described above or below may be combined, unless explicitly stated otherwise.

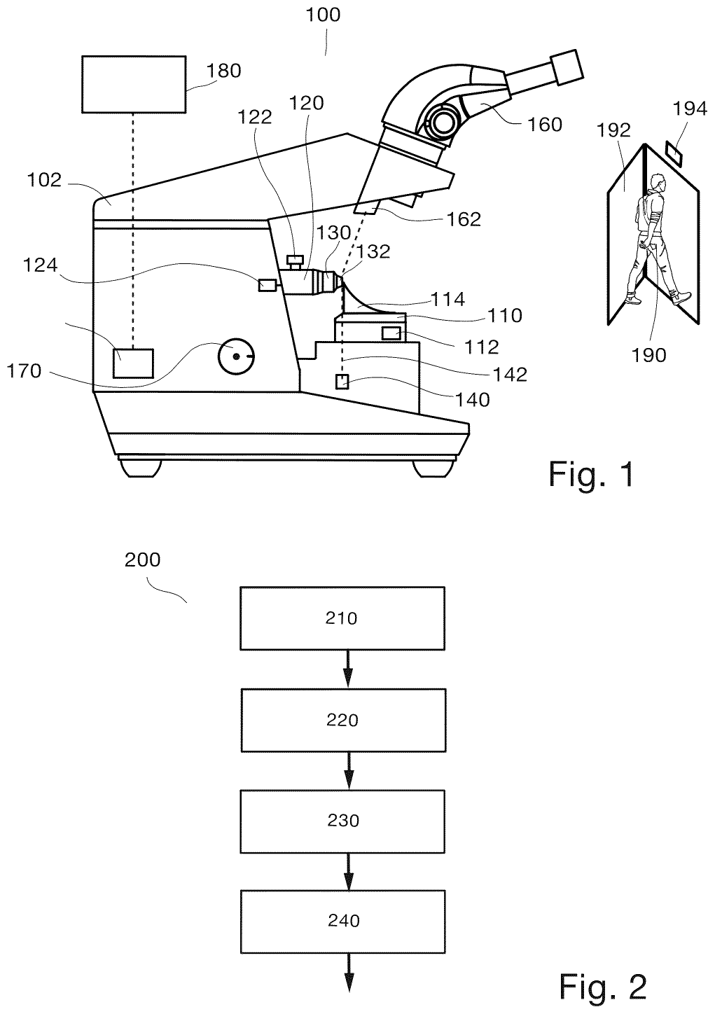

FIG. 1 shows a microtome 100 according to an embodiment of the present disclosure. Microtome 100 includes a housing 102, which accommodates the components of the microtome. Microtome 100 includes a knife holder (or blade holder) 110 configured to a hold a knife 114. The knife holder is movable in different directions by actuator system 112. Knife 114 includes a cutting edge, which performs a cut and may be made of glass or diamond, for example.

Microtome 100 includes a sample holder 120 that can be actuated in at least two translational and two rotational degrees of freedom by actuator systems 122, 124. Sample holder 120 is configured to hold a sample 130. Sample 130 includes a block face 132, which is a portion in which a cutting operation is to take place. The area of the block face and the blade can be illuminated by a light source 140, which emits a light beam 142.

Microtome system 100 includes a microscope 160 mounted on housing 102 and configured such that a user can view (and inspect) blade 114 and a block face 132 of a sample 130. This allows a user, for example, to check the cutting movement and/or the quality of knife edge 116. The light produced by illumination source 140, which illuminates the (physical) gap between sample 130 (or its block face 132) and blade 114, is captured by detector (objective) 162 of microscope 160 (e.g., via a camera).

A cutting operation can be controlled by a mechanical element, namely rotary wheel 170. Microtome system 100 further includes a user interface 180 on which information about a cutting operation and/or instructions for aligning a knife 114 relative to a block face 132 of a sample 130 can be displayed to a user, and via which commands, in particular adjustment commands, can be entered. The user interface may be disposed on the microtome or may be a remote user interface located in a different room or in a place. A remote user interface may exchange information with one or more microtomes via a suitable communication interface, for example, a communication network. An adjustment may also be carried out via a remote user interface.

If user interface 180 is on the microtome or in the same room as the microtome, an adjustment can be activated and carried out by the microtome only after a user performing the activation has moved sufficiently far away from the microtome or left the room. In particular, sensor means may determine that no one is near the microtome before an activated adjustment is carried out. For example, a closing of a door 192 from outside may be observed by a sensor 194, and it can thus be determined that user 190 has left the room in which is located a microtome whose adjustment was activated by this user. In addition or alternatively, the start of an activated adjustment may be delayed by a timer, so that the user activating the adjustment can leave the room. Another way to determine that a room is empty before an adjustment of a microtome starts is via a motion sensor located in the room of the microtome. An adjustment should not be started as long as the motion sensor senses movements.

If user interface 180 is located in another room or in another place, it can be determined, also via a motion sensor and/or via a camera, whether the room is free from humans before an adjustment is started. This checking may be done automatically or by a user located at the remote user interface.

FIG. 2 illustrates a method 200 for adjusting a microtome according to embodiments of this disclosure, for example, a microtome as shown in FIG. 1.

In a first step 210, a position of a sample and a position of a knife are detected to make actual values available for an adjustment. Concurrently with the position detection, in particular, a water tank of a knife of the microtome may be filled with water in order that the sectioning of a sample already present in the sample holder can be started promptly after the adjustment is completed.

In a second step 220, adjustment information about the sample and about the knife is obtained. The information may be selected or entered, for example, via the user interface. The adjustment information may include information about alignment marks on the sample and on the knife. In addition, the adjustment information may include information about how close to the sample the knife is to be positioned by the adjustment, i.e., about the desired distance between the knife and the sample after an adjustment has been made. Moreover, the adjustment information may include information that is used to position the knife and the sample such that a flat, straight cut can be made. For this purpose, for example, a shape between a block face of a sample and a cutting edge of a knife may be analyzed. This information may be captured, for example, by a camera.

In a third step 230, the adjustment is activated. After activation, an adjustment may start immediately, particularly if it is determined that no predetermined sources of disturbance (e.g., humans) are present in the room. Immediate starting of an adjustment may occur especially if the adjustment is commanded via a remote user interface that is located outside of a room in which the microtome to be adjusted is located.

In a fourth step 240, the previously configured adjustment is performed, and the knife is aligned relative to the sample accordingly. In the process, actual positions of the sample and the knife may be monitored by the camera and/or by position sensors in the joints of the sample holder and of the knife holder. There may also be sensors in the drives. The adjustment may take place in a fully automated manner. In addition, the user may be able to perform the adjustment manually via the user interface. This can in particular allow experienced users, who can perform adjustments better than the automatic adjustment, to carry out the adjustment. In addition or alternatively, a started adjustment can be interrupted or terminated via the user interface, in particular via a remote user interface. This may be done, for example, if it is determined that a started adjustment cannot be completed without disturbance, for example, because a camera detects that a human has entered the room in which the microtome to be adjusted is located. This is because the entrance of a human can cause vibrations which may distort an adjustment or make it unusable.

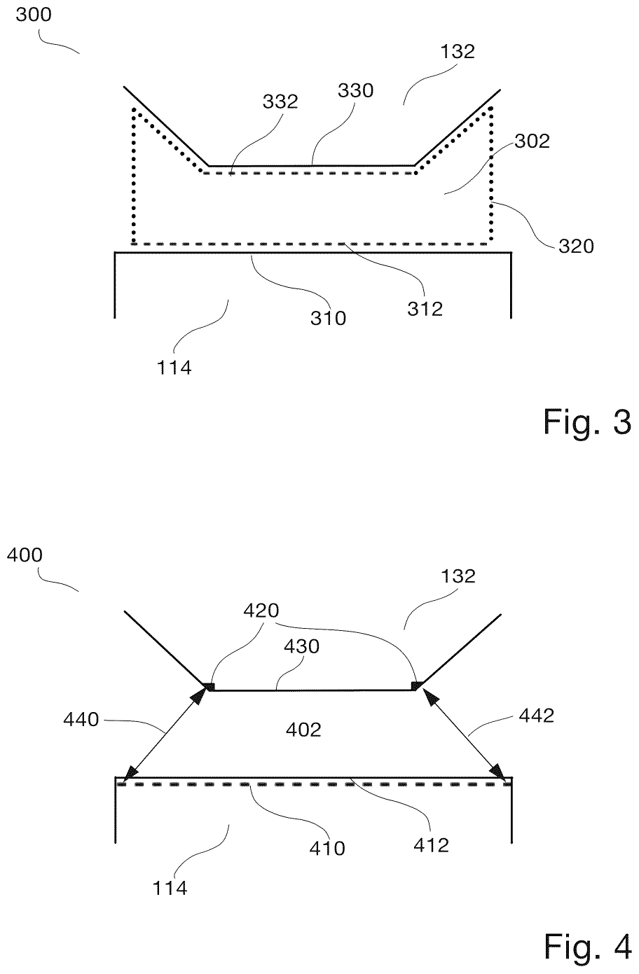

FIG. 3 illustrates a method for adjusting a microtome based on shape-based adjustment information, according to embodiments of this disclosure. There is shown a top view of a sample area 300 including a light gap 302. Light gap 302 is formed between a cutting edge 310 of a knife 114 and a sample 132. Light (e.g., from light source 140) may pass through light gap 302 (i.e., a space located between cutting edge 310 and sample 132) and may be captured by a camera.

Light gap 302 has a contour 320. The first portion 312 of the contour or shape 320 is formed by cutting edge 310. A second portion 332 of contour 320 is formed by sample 132 or sample surface (block face) 330.

Prior to the cutting operation, sample 132 may be precisely positioned relative to knife 114 in an approach operation. For this purpose, a computer-implemented method may be used. The computer-implemented method may include, in one step, determining light gap 300, the light gap 300 being sensed by a camera.

Light gap 300 may be partially defined by cutting edge 114 and sample 122. In other words, the adjustment includes aligning knife 114 and/or sample 132 such that light gap 300 has a predetermined shape. The predetermined shape may include an angular shape, in particular a rectangular shape.

FIG. 4 illustrates a method for adjusting a microtome based on marker-based adjustment information, according to embodiments of this disclosure. There is shown a top view of a sample area 400 including a light gap 402 between the sample and the knife. Light gap 402 is formed between a cutting edge 412 of a knife 114 and a block face 430 of a sample 132. Knife 114 and sample 132 can be detected and tracked by a camera.

The knife is provided at its edge with markers 410, which are disposed parallel and immediately adjacent to cutting edge 412. Markings 410 can be effectively identified in the image captured by the camera through image processing, so that a position of the knife is known. Moreover, the sample has a marking 420 at each of the corners of the block face, the markings being usable by an adjustment algorithm for orientation purposes.

The adjustment of the microtome may be performed such that the magnitude of distances 440, 442 must take a predetermined value. Alternatively, it may be required that the markings 410 on the knife must be parallel to cutting edge 412 and, at the same time, that distances 440, 442 should be minimized in terms of their sum. This makes it possible to find a position where the knife is parallel to block face 430 of the sample and where sample 132 is disposed centrally with respect to knife 114.

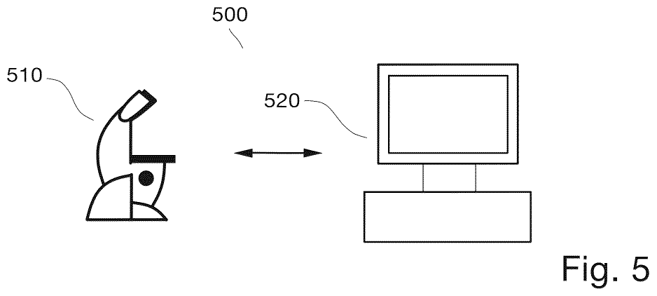

Some embodiments relate to a microscope that includes a system as described in connection with one or more of FIGS. 1 through 4. Alternatively, a microscope may form part of, or be connected to, a system as described in connection with one or more of FIGS. 1 through 4. FIG. 5 illustrates, in schematic form, a system 500 configured to perform a method as described herein. System 500 includes a microscope 510 and a computer system 520. Microscope 510 is configured to capture images and is connected to computer system 520. Computer system 520 is configured to perform at least a portion of a method described herein. Computer system 520 may be configured to execute a machine learning algorithm. Computer system 520 and microscope 510 may be separate units, but may also be integrated into a common housing. Computer system 520 may be part of a central processing system of microscope 510 and/or computer system 520 may be part of a subcomponent of microscope 510, such as, for example, a sensor, an actuator, a camera, or an illumination unit, etc., of microscope 510.

Computer system 520 may be a local computer device (e.g., personal computer, laptop, tablet computer, or mobile phone) having one or more processors and one or more memory devices or may be a distributed computer system (e.g., a cloud computing system having one or more processors and one or more memory devices distributed at different locations, such as, for example, at a local client and/or one or more remote server farms and/or data centers). Computer system 520 may include any circuit or combination of circuits. In an embodiment, computer system 520 may include one or more processors of any type. As used herein, the term “processor” may refer to any type of computational circuit, such as, for example, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field-programmable gate array (FPGA) of, for example, a microscope or a microscope component (e.g., camera), or a different type of microscope e.g., camera), or any other type of processor or processing circuit. Other types of circuits that may be included in computer system 520 include a custom-built circuit, an application-specific integrated circuit (ASIC), or the like, such as, for example, one or more circuits (e.g., a communication circuit) for use in wireless devices such as mobile phones, tablet computers, laptop computers, radio phones, and similar electronic systems. Computer system 520 may include one or more memory devices, which may include one or more memory elements suitable for the particular application, such as, for example, a main memory in the form of a random access memory (RAM), one or more hard disks, and/or one or more drives that handle removable media such as CDs, flash memory cards, digital video disks (DVDs), and the like. Computer system 520 may also include a display device, one or more loudspeakers, and a keyboard, and/or a controller, which may include a mouse, a trackball, a touch screen, a speech recognition device, or any other device allowing a system user to input information to computer system 520 and receive information therefrom.

Some or all of the method steps may be performed by a hardware apparatus (or using a hardware apparatus), such as, for example, a processor, a microprocessor, a programmable computer, or an electronic circuit. In some embodiments, one or more of the most important method steps may be performed by such an apparatus.

Depending on certain implementation requirements, embodiments of the invention can be implemented in hardware or in software. The implementation can be performed using a non-transitory storage medium such as a digital storage medium, for example a floppy disk, a DVD, a Blu-Ray, a CD, a ROM, a PROM, an EPROM, an EEPROM, or a FLASH memory, having electronically readable control signals stored thereon, which cooperate (or are capable of cooperating) with a programmable computer system such that the respective method is performed. Therefore, the digital storage medium may be computer-readable.

Some embodiments of the invention include a data carrier with electronically readable control signals which are capable of cooperating with a programmable computer system such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments include the computer program for performing one of the methods described herein, stored on a machine-readable carrier.

In other words, one exemplary embodiment of the present invention is therefore a computer program having a program code for performing one of the methods described herein when the computer program runs on a computer.

A further embodiment of the present invention is therefore a storage medium (or a data carrier or a computer-readable medium) having stored thereon the computer program for performing one of the methods described herein when executed by a processor. The data carrier, the digital storage medium, or the recorded medium are typically tangible and/or non-transferable. Another embodiment of the present invention is an apparatus as described herein including a processor and the storage medium.

A further embodiment of the invention is therefore a data stream or a sequence of signals representing the computer program for performing one of the methods described herein. The data stream or the sequence of signals may, for example, be configured to be transferable via a data communication connection, for example via the Internet.

A further embodiment includes a processing means, for example, a computer or a programmable logic device, configured or adapted to perform one of the methods described herein.

A further embodiment includes a computer having installed thereon the computer program for performing one of the methods described herein.

A further embodiment of the invention includes an apparatus or a system configured to transfer (for example, electronically or optically) a computer program for performing one of the methods described herein to a receiver. The receiver may be, for example, a computer, a mobile device, a memory device, or the like. The apparatus or system may, for example, include a file server for transferring the computer program to the receiver.

In some embodiments, a programmable logic device (e.g., a field-programmable gate array (FPGA)) may be used to perform some or all of the functions of the methods described herein. In some embodiments, a field-programmable gate array may cooperate with a microprocessor in order to perform one of the methods described herein. Generally, the methods are preferably performed by any hardware apparatus.

As used herein, the term “and/or” includes any and all combinations of one or more of the listed aspects and may be abbreviated as “/”.

Although some aspects have been described in the context of a device, it is clear that these aspects also represent a description of the corresponding method, where a block or device corresponds to a method step or a feature of a method step. Analogously, aspects described in the context of a method step also represent a description of a corresponding block or item or feature of a corresponding device.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

100 microtome
102 housing
110 knife holder
112 actuator system
114 knife
120 sample holder
122 actuator system
124 actuator system
130 sample
132 block face
140 light source
142 light beam
160 microscope
162 detector
170 rotary wheel
180 user interface
190 user activating the adjustment
192 door
194 door sensor
200 adjustment method
210 first adjustment step
220 second adjustment step
230 third adjustment step
240 fourth adjustment step
300 sample area
302 light gap
310 cutting edge
312 first portion of the shape
320 contour
330 sample surface
332 second portion of the shape
400 sample area
402 gap
410 marker on the knife
412 cutting edge
420 markings on the sample
430 block face
440 left distance
442 right distance
500 microscope system
510 microscope
520 computer

1. A microtome, comprising:
one or more motor drives for moving a sample and for moving a knife; and
a user interface;
wherein the microtome is configured to:
detect a position of the sample;
detect a position of the knife;
obtain adjustment information about the sample;
obtain adjustment information about the knife; and
adjust the microtome based on the position of the sample, the position of the knife, the adjustment information about the sample, the adjustment information about the knife, and a command from the user interface.

2. The microtome as recited in claim 1,
wherein the user interface comprises a remote user interface, and the adjustment is controlled via the remote user interface.

3. The microtome as recited in claim 1,
wherein the microtome is configured to:
obtain a positioning command from the user interface for positioning the sample and/or the knife during the adjusting the microtome.

4. The microtome as recited in claim 3,
wherein the positioning command includes one or more of following information items:
position-based information; or
shape-based information.

5. The microtome as recited in claim 1,
wherein one or more of following commands are captured by the user interface:
a command to start the adjustment;
a command to terminate the adjustment;
a command to interrupt the adjustment; or
a command to perform a manual adjustment.

6. The microtome as recited in claim 1, further comprising one or more position sensors for detecting the position of the sample and/or a position of a sample holder.

7. The microtome as recited in claim 6, further comprising a camera for simultaneously detecting the position of the sample and/or the position of the sample holder, and the position of the knife.

8. The microtome as recited in claim 1,
wherein the adjustment information about the sample includes at least one of following information:
a position on a sample holder;
a position on a block face of the sample;
a distance from the sample or from the sample holder;
a marking on the sample or on the sample holder; or
a geometric property of the sample or of the sample holder.

9. The microtome as recited in claim 1,
wherein adjustment information about the knife includes at least one of following information:
a position on a knife holder;
a position on the knife;
a distance from the knife and/or from the knife holder;
a marking on the knife or on the knife holder; or
a geometric property of the knife or of the knife holder.

10. The microtome as recited in claim 1,
wherein the sample and/or the knife include(s) one or more position markings.

11. The microtome as recited in claim 10,
wherein both the sample and the knife have position markings forming a vernier.

12. The microtome as recited in claim 1,
wherein the microtome is further configured to:
check whether there are sources of mechanical disturbances near the microtome.

13. The microtome as recited in claim 1,
further comprising a pump for emptying and filling a water tank disposed on the knife.

14. The microtome as recited in claim 13,
wherein one or more of following commands are captured by the user interface:
a command to empty the water tank of the knife; or
a command to fill the water tank of the knife.

15. A computer-implemented method for adjusting a microtome, the method comprising:
detecting a position of a sample;
detecting a position of a knife;
obtaining adjustment information about the sample;
obtaining adjustment information about the knife;
obtaining an adjustment command via a user interface; and
adjusting the sample relative to the knife based on the position of the sample, the position of the knife, the adjustment information about the sample, the adjustment information about the knife, and the adjustment command.
